(19) United States
(12) Patent Application Publication
(10) Pub. No.: US 2020/0359707 A1
(43) Pub. Date: Nov. 19, 2020

(54) VAPORIZER

(71) Applicant: Tuanfang LIU, Shenzhen (CN)

(72) Inventor: Tuanfang LIU, Shenzhen (CN)

(21) Appl. No.: 16/680,526

(22) Filed: Nov. 12, 2019

(30) Foreign Application Priority Data
May 13, 2019 (CN) 201910395116.2
May 13, 2019 (CN) 201920676800.3

(51) Int. Cl. A24F 47/00; H05B 1/02

(52) U.S. Cl. CPC A24F 47/008; F16J 15/022; H05B 1/0208

(57) ABSTRACT

A vaporizer including a cover; a first sleeve; a silicone gasket; a first heating unit; a second heating unit; a first support supporting the first heating unit; a second support supporting the second heating unit; two electrodes; a third support supporting the two electrodes; a printed circuit board; a silicone seal; a pneumatic switch; a fourth support supporting the pneumatic switch; a second sleeve; a thread ring; a button; a support frame; a base frame; a control plate; a light guide column; a battery; a first end cover; and a second end cover. The cover is disposed on the side wall of the base frame and is capable of turning inside out with respect to the side wall. The first sleeve is disposed in the base frame and includes an opening, and the cover is adapted to cover or uncover the opening.

### CROSS-REFERENCE TO RELAYED APPLICATIONS

Pursuant to 35 U.S.C. § 119 and the Paris Convention Treaty, this application claims foreign priority to Chinese Patent Application No. 201910395116.2 filed May 13, 2019, and to Chinese Patent Application No. 201920676800.3 filed May 13, 2019. The contents of all of the aforementioned applications, including any intervening amendments thereto, are incorporated herein by reference. Inquiries from the public to applicants or assignees concerning this document or the related applications should be directed to: Matthias Scholl P C., Attn.: Dr. Matthias Scholl Esq., 245 First Street, 18th Floor, Cambridge, Mass. 02142.

### BACKGROUND

The disclosure relates to a vaporizer.

A vaporizer, colloquially known as a vape, is a device used to vaporize substances such as tobacco for inhalation.

### SUMMARY

The disclosure provides a vaporizer.

The vaporizer comprises a cover; a first sleeve; a silicone gasket; a first heating unit; a second heating unit; a first support supporting the first heating unit; a second support supporting the second heating unit; two electrodes; a third support supporting the two electrodes; a printed circuit board; a silicone seal; a pneumatic switch; a fourth support supporting the pneumatic switch; a second sleeve; a thread ring; a button; a support frame; a base frame; a control plate; a light guide column; a battery; a first end cover; and a second end cover.

The cover is disposed on a side wall of the base frame and is capable of turning inside out with respect to the side wall; the first sleeve is disposed in the base frame and comprises an opening configured to receive a cigarette, and the cover is adapted to cover or uncover the opening; the silicone gasket is disposed in the first sleeve; the first heating unit is disposed on the first support; and the first heating unit and the first support are disposed in the first sleeve; the second heating unit is disposed on the second support; the two electrodes are disposed on the third support; and the two electrodes and the third support are disposed in the second support; the second support is disposed in the base frame; the silicone seal sleeves the printed circuit board; the printed circuit board is disposed on the fourth support; the pneumatic switch, the second sleeve, and the thread ring are embedded sequentially in that order in the fourth support; and the fourth support is screwed to the second support; and the light guide column is disposed on the control plate, and the control plate is disposed on the base frame; the button is disposed in the support frame; the battery is disposed in the base frame; and the first end cover and the second end cover are disposed on two opposite sides of the base frame, respectively.

Advantages of the vaporizer according to embodiments of the disclosure are summarized as follows. The cover is disposed on the side wall of the base frame and is capable of turning inside out with respect to the side wall and is next to the opening of the base frame. The first sleeve is disposed in the base frame and comprises an opening. A cigarette can be inserted in the first sleeve via the opening and contacts the first heating unit. Press the button can power on the vaporizer, and the first heating unit starts to work and vaporize the cigarette. Upon inhaling, the vapor activates the pneumatic switch and the second heating unit starts to vaporize the cigarette. Thus, the side and the bottom of the cigarette can be synchronously heated by the first heating unit and the second heating unit, respectively, which can accelerate the volatilization and degradation of harmful substances in the cigarette.

### BRIEF DESCRIPTION OF THE DRAWINGS

FIG. 1 is an exploded view of a vaporizer according to one embodiment of the disclosure;

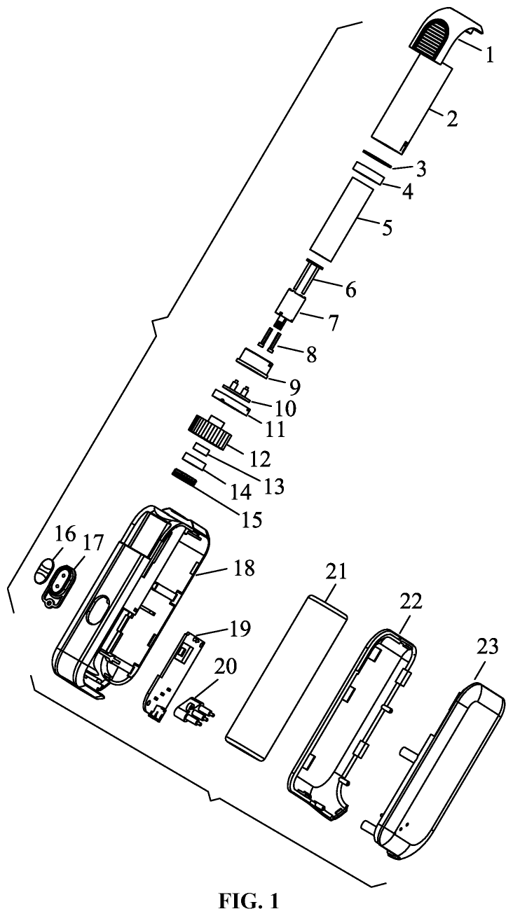

FIG. 2 is a schematic diagram of a vaporizer according to one embodiment of the disclosure; and

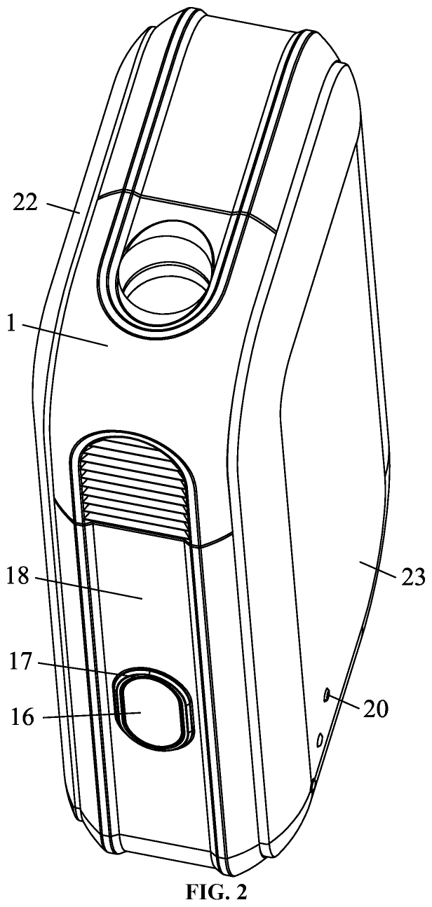

FIG. 3 is a sectional view of a vaporizer according to one embodiment of the disclosure.

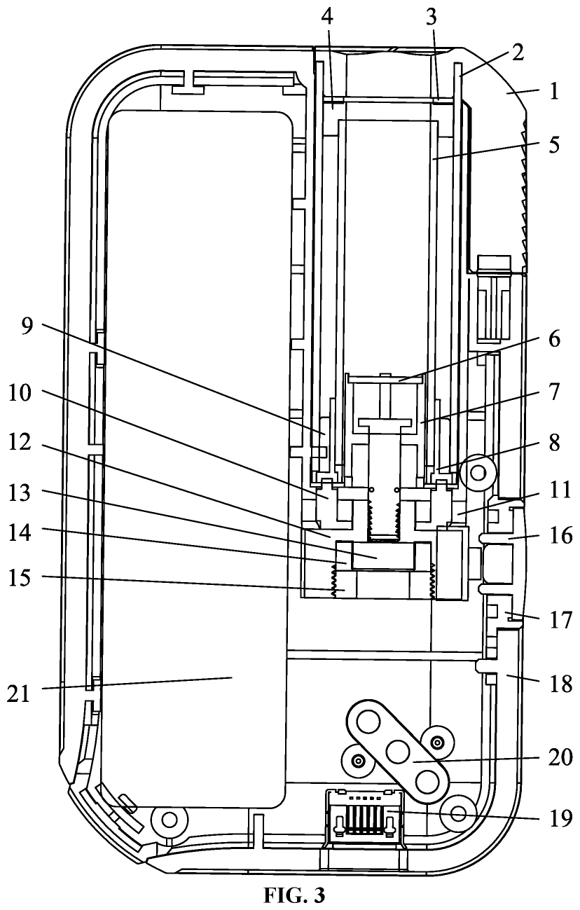

### DETAILED DESCRIPTION

To further illustrate, embodiments detailing a vaporizer are described below. It should be noted that the following embodiments are intended to describe and not to limit the disclosure.

A vaporizer comprises a cover 1; a first sleeve 2; a silicone gasket 3; a first heating unit 5; a second heating unit 6; a first support 4 supporting the first heating unit 5; a second support 7 supporting the second heating unit 6; two electrodes 8; a third support 9 supporting the two electrodes 8; a printed circuit board 10; a silicone seal 11; a pneumatic switch 13; a fourth support 12 supporting the pneumatic switch 13; a second sleeve 14; a thread ring 15; a button 16; a support frame 17; a base frame 18; a control plate 19; a light guide column 20; a battery 21; a first end cover 22; and a second end cover 23.

The cover 1 is disposed on a side wall of the base frame 18 and is capable of turning inside out with respect to the side wall; the first sleeve 2 is disposed in the base frame 18 and comprises an opening configured to receive a cigarette, and the cover 1 is adapted to cover or uncover the opening; the silicone gasket 3 is disposed in the first sleeve 2; the first heating unit 5 is disposed on the first support 4; and the first heating unit 5 and the first support 4 are disposed in the first sleeve 2; the second heating unit 6 is disposed on the second support 7; the two electrodes 8 are disposed on the third support 9; and the two electrodes 8 and the third support 9 are disposed in the second support 7; the second support 7 is disposed in the base frame 18; the silicone seal 11 sleeves the printed circuit board 10; the printed circuit board 10 is disposed on the fourth support 12; the pneumatic switch 13, the second sleeve 14, and the thread ring 15 are embedded sequentially in that order in the fourth support 12; and the fourth support 12 is screwed to the second support 7; and the light guide column 20 is disposed on the control plate 19, and the control plate 19 is disposed on the base frame 18; the button 16 is disposed in the support frame 17; the battery 21 is disposed in the base frame 18; and the first end cover 22 and the second end cover 23 cover two opposite sides of the base frame 18, respectively.

The cover 1 is disposed on the side wall of the base frame 18 and is capable of turning inside out with respect to the side wall and is next to the opening of the base frame. The first sleeve 2 is disposed in the base frame and comprises an opening. A cigarette can be inserted in the first sleeve 2 via the opening and contacts the first heating unit 5. Press the button can power on the vaporizer, and the first heating unit 5 starts to work and vaporize the cigarette. Upon inhaling, the vapor activates the pneumatic switch 13 and the second heating unit 6 starts to vaporize the cigarette. Thus, the side and the bottom of the cigarette can be synchronously heated by the first heating unit 5 and the second heating unit 6, respectively, which can accelerate the volatilization and degradation of harmful substances in the cigarette.

It will be obvious to those skilled in the art that changes and modifications may be made, and therefore, the aim in the appended claims is to cover all such changes and modifications.

What is claimed is:

1. A device, comprising:
1) a cover;
2) a first sleeve;
3) a silicone gasket;
4) a first heating unit;
5) a second heating unit;
6) a first support supporting the first heating unit;
7) a second support supporting the second heating unit;
8) two electrodes;
9) a third support supporting the two electrodes;
10) a printed circuit board;
11) a silicone seal;
12) a pneumatic switch;
13) a fourth support supporting the pneumatic switch;
14) a second sleeve;
15) a thread ring;
16) a button;
17) a support frame;
18) a base frame;
19) a control plate;
20) a light guide column;
21) a battery;
22) a first end cover; and
23) a second end cover;
wherein:
the cover is disposed on a side wall of the base frame and is capable of turning inside out with respect to the side wall;
the first sleeve is disposed in the base frame and comprises an opening configured to receive a cigarette, and the cover is adapted to cover or uncover the opening;
the silicone gasket is disposed in the first sleeve;
the first heating unit is disposed on the first support; and the first heating unit and the first support are disposed in the first sleeve;
the second heating unit is disposed on the second support;
the two electrodes are disposed on the third support; and the two electrodes and the third support are disposed in the second support;
the second support is disposed in the base frame;
the silicone seal sleeves the printed circuit board; the printed circuit board is disposed on the fourth support;
the pneumatic switch, the second sleeve, and the thread ring are embedded sequentially in that order in the fourth support; and the fourth support is screwed to the second support; and
the light guide column is disposed on the control plate, and the control plate is disposed on the base frame; the button is disposed in the support frame; the battery is disposed in the base frame; and the first end cover and the second end cover are disposed on two opposite sides of the base frame, respectively.
